(19) United States
(12) Patent Application Publication
(10) Pub. No.: US 2023/0206479 A1
(43) Pub. Date: Jun. 29, 2023

(54) IMAGE PROCESSING APPARATUS AND IMAGE PROCESSING METHOD

(71) Applicant: JVCKENWOOD Corporation, Yokohama-shi (JP)

(72) Inventor: Etsuro MOMIYAMA, Yokohama-shi (JP)

(21) Appl. No.: 18/057,136

(22) Filed: Nov. 18, 2022

(30) Foreign Application Priority Data
Dec. 24, 2021 (JP) 2021-210626
Dec. 24, 2021 (JP) 2021-210627

(51) Int. Cl. G06T 7/50; G06T 7/90; H04N 9/73

(52) U.S. Cl. CPC G06T 7/50; G06T 7/90; H04N 9/73; G06T 2207/10024

(57) ABSTRACT

An image processing apparatus according to the present embodiment includes a detection unit configured to detect a subject region in a captured image, an acquisition unit configured to acquire, on a per-pixel basis, color information and depth information of a pixel included in the subject region, a color determination unit configured to determine a color of the pixel based on the color information, and a correction unit configured to correct the depth information of the pixel based on a determination result from the color determination unit. When the pixel is a chromatic pixel, the correction unit corrects the depth information of the pixel based on correction information that is associated with the color of the pixel.

### CROSS REFERENCE TO RELATED APPLICATION

This application is based upon and claims the benefit of priority from Japanese patent application No. 2021-210626, filed on Dec. 24, 2021, and Japanese patent application No. 2021-210627, filed on Dec. 24, 2021, the disclosure of which is incorporated herein in its entirety by reference.

### BACKGROUND

The present disclosure relates to an image processing apparatus and an image processing method.

As a technique for measuring a distance (depth) from an image capturing apparatus to a subject, there is known a Time of Flight (ToF) method. A ToF sensor that uses the ToF method radiates a distance measuring light of infrared light toward a subject, and receives the distance measuring light reflected from the subject by an infrared image pickup element. The ToF sensor may calculate a distance between the subject and the image capturing apparatus by detecting a time difference from radiation to reception of light on a per-pixel basis.

For example, as a related technique, Published Japanese Translation of PCT International Publication for Patent Application, No. 2021-521543 discloses an image processing apparatus including a sensor of a first type, a sensor of a second type, and a control circuit. With the image processing apparatus, the control circuit receives an input color image frame from the sensor of the first type, and receives an input depth image corresponding to the input color image frame, from the sensor of the second type.

Accuracy of distance measurement regarding a distance (depth value) to a subject that is obtained by the ToF sensor is different depending on a color of the subject. This is because reflectance is different depending on the color of the subject. Accordingly, for example, even in a case where subjects of different colors are positioned at the same distance from the ToF sensor, different distances are possibly measured depending on colors of the subjects.

Furthermore, a black subject has small reflectance, and thus, a depth value is possibly not normally acquired by the ToF sensor. Accordingly, in the case where a 3D image is generated based on the depth value, the depth value of a black subject is assumed not to be present, and there are problems that a part that is supposed to be a plane surface becomes hollow, or a planar subject is made three-dimensional as an object with asperity, for example.

### SUMMARY

An image processing apparatus according to a present embodiment includes:

a detection unit configured to detect a subject region in a captured image;

an acquisition unit configured to acquire, on a per-pixel basis, color information and depth information of a pixel included in the subject region;

a color determination unit configured to determine a color of the pixel based on the color information; and

a correction unit configured to correct the depth information of the pixel based on a determination result from the color determination unit,

in which, when the pixel is a chromatic pixel, the correction unit corrects the depth information of the pixel based on correction information that is associated with the color of the pixel.

An image processing method according to the present embodiment includes:

a detection step of detecting a subject region in a captured image;

an acquisition step of acquiring, on a per-pixel basis, color information and depth information of a pixel included in the subject region;

a color determination step of determining a color of the pixel based on the color information; and

a correction step of correcting the depth information of the pixel based on a determination result in the color determination step,

in which, in the correction step, when the pixel is a chromatic pixel, the depth information of the pixel is corrected based on correction information that is associated with the color of the pixel.

An image processing apparatus according to the present embodiment includes:

a detection unit configured to detect a subject region in a captured image;

an acquisition unit configured to acquire, on a per-pixel basis, color information and depth information of a pixel included in the subject region;

a color determination unit configured to determine a color of the pixel based on the color information; and

a correction unit configured to correct the depth information of the pixel based on a determination result from the color determination unit,

in which, when the pixel is a black pixel, the correction unit corrects the depth information of the pixel based on the depth information of a chromatic pixel that is in a neighborhood of the pixel.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration of an image capturing system according to an embodiment;

FIG. 2 is a diagram showing, as an example of a captured image, a captured image including a plurality of subjects;

FIG. 3 is a diagram showing an example of arrangement, in an array, of RGB values and depth values in a subject region;

FIG. 4 is an explanatory diagram of a first correction method for a black pixel;

FIG. 5 is a diagram describing a modified example of the first correction method for the black pixel;

FIG. 6 is an explanatory diagram of a second correction method for the black pixel;

FIG. 7 is an explanatory diagram of a third correction method for the black pixel;

FIG. 8 is an explanatory diagram of the third correction method for the black pixel;

FIG. 9 is a diagram describing a modified example of the third correction method for the black pixel;

FIG. 10 is an explanatory diagram of a fourth correction method for the black pixel;

FIG. 11 is an explanatory diagram of the fourth correction method for the black pixel;

FIG. 12 is a flowchart showing a process performed by an image processing apparatus; and

FIG. 13 is a flowchart showing a depth correction process for a chromatic pixel.

### DETAILED DESCRIPTION

Hereinafter, an embodiment of the present disclosure will be described in detail with reference to the drawings. Same or corresponding elements in each drawing are denoted by a same reference sign. For the clarity of description, overlapping description is omitted as necessary.

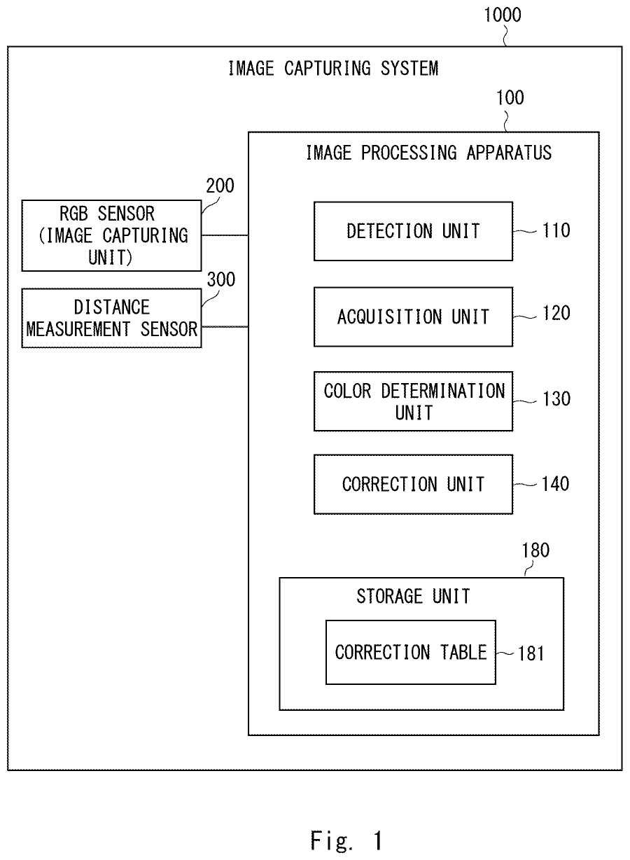

FIG. 1 is a block diagram showing a configuration of an image capturing system 1000 according to a present embodiment.

The image capturing system 1000 includes an RGB sensor (image capturing unit) 200, a distance measurement sensor 300, and an image processing apparatus 100. The image capturing system 1000 is an information processing system that can capture a subject using the RGB sensor 200 and the distance measurement sensor 300, and of performing predetermined image processing at the image processing apparatus 100.

The RGB sensor 200 is a sensor that can capture a subject, and of detecting color information. For example, the color information is an RGB value defined in an sRGB space. The color information may also take a form of an RGB value defined in an Adobe (registered trademark) RGB space, or a Lab value defined in a Lab space.

The RGB sensor 200 performs a process including at least one of an automatic white balance (hereinafter referred to as “AWB”) process and an automatic exposure (hereinafter referred to as “AE”) process, and captures the subject. In the AWB process, a state of a light source of a capturing target is automatically determined, and a state of an appropriate color is reproduced. The RGB sensor 200 may always perform the AWB process or at a timing of preparing for capturing. The AE process is for controlling an aperture, a shutter speed and the like based on luminance information of a capturing field of view to maintain constant brightness of a captured image.

In the present embodiment, the RGB sensor 200 performs both the AWB and AE processes, and outputs a captured image to the image processing apparatus 100. The captured image may be a still image or a moving image. Furthermore, the RGB sensor 200 outputs the RGB value of each pixel of the captured image to the image processing apparatus 100. For example, the RGB sensor 200 is a color still camera (such as an RGB camera) or a color video camera.

The distance measurement sensor 300 is a sensor that is capable of capturing a subject, and of detecting depth information. The depth information is information indicating a depth in a perspective direction of a subject. For example, the depth information is expressed by a depth value indicating a distance from the distance measurement sensor 300. The depth value may be expressed by a physical unit indicating a distance from the distance measurement sensor 300 to the subject in millimeters or the like, or may be expressed by the distance that is normalized in a range of 0 to 1.

The distance measurement sensor 300 outputs the depth value of each pixel of the captured image to the image processing apparatus 100. For example, the distance measurement sensor 300 is a ToF sensor or a stereo camera, but this is not restrictive. Various sensors that are capable of detecting the distance between the distance measurement sensor 300 and the subject may be used as the distance measurement sensor 300.

The image processing apparatus 100 is an information processing apparatus that performs image processing by acquiring the RGB value and the depth value from the RGB sensor 200 and the distance measurement sensor 300. The image processing apparatus 100 includes a detection unit 110, an acquisition unit 120, a color determination unit 130, a correction unit 140, and a storage unit 180.

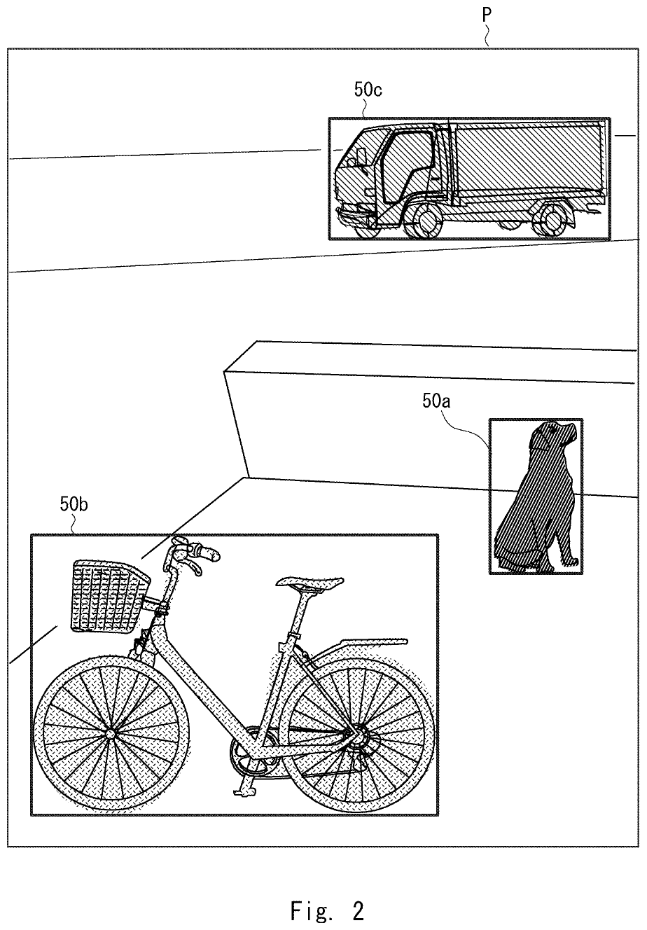

The detection unit 110 acquires a captured image from the RGB sensor 200, and detects a subject region in the captured image. FIG. 2 is a diagram showing, as an example of the captured image, a captured image P including a plurality of subject. The subjects may be anything including a person, an animal, a vehicle and the like. The captured image P includes a dog, a bicycle, and a truck as the subjects. Additionally, the present embodiment shows an example where the captured image P includes three subjects, but the number of subjects is not limited to three, and may be one.

A subject region is a region, in the captured image P, including a subject that is a detection target. For example, the subject region may indicate a circumscribed rectangular region of the subject. As shown in FIG. 2, the detection unit 110 detects subject regions 50a to 50c corresponding to the dog, the bicycle, and the truck, respectively.

A known object detection technique may be used for detection of the subject region. For example, the detection unit 110 detects the subject using a deep neural network (DNN) that is trained in advance to detect a subject included in the captured image P. As an object detection algorithm, a Faster R-CNN (Region-based Convolutional Neural Network), YOLO (You Only Look Once), SSD (Single Shot Multibox Detector) or the like may be used, for example. The detection unit 110 may perform detection of the subject region using any method without being limited to those listed above.

Additionally, in the following, the subject regions 50a to 50c may be described by being referred to collectively as “subject region(s)”.

The detection unit 110 assigns an identification number for identifying a subject region detected in the captured image P, to each subject region. For example, the detection unit 110 assigns identification numbers “1”, “2”, and “3” to the dog, the bicycle, and the truck. In the present embodiment, “50a”, “50b”, and “50c” mentioned above are used as the identification numbers.

A description will be given again by referring back to FIG. 1.

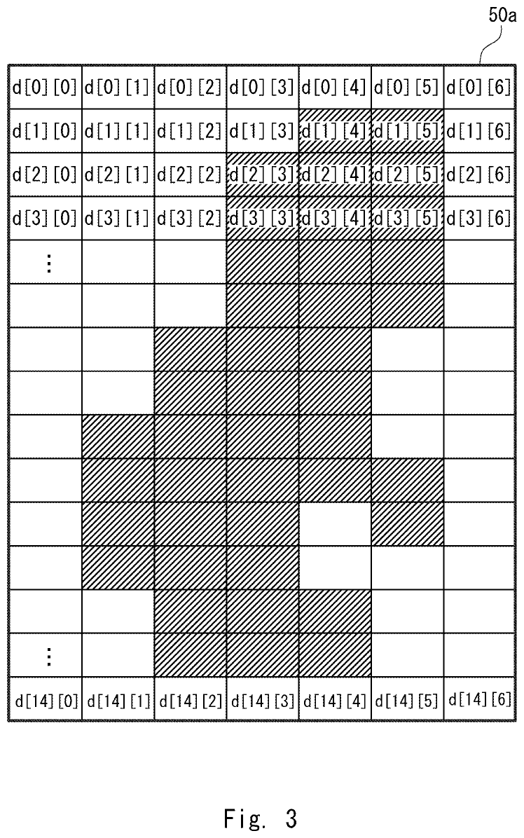

The acquisition unit 120 acquires on a per-pixel basis, and arranges in an array, the color information and the depth information of the pixel included in the subject region detected by the detection unit 110. In the present embodiment, the color information is the RGB value that is output from the RGB sensor 200, and the depth information is the depth value that is output from the distance measurement sensor 300. FIG. 3 is a diagram showing an example of arrangement, in an array, of the RGB values and the depth values in the subject region 50a. In the example in FIG. 3, an array of 15 rows and 7 columns is shown as an example.

Furthermore, the acquisition unit 120 acquires AWB information about the AWB process from the RGB sensor 200, and AE information about the AE process from the detection unit 110. The acquisition unit 120 may also acquire the AWB information and the AE information based on the captured image.

A description will be given again by referring back to FIG. 1.

The color determination unit 130 determines a color of each pixel based on the color information acquired by the acquisition unit 120. For example, the color determination unit 130 first determines whether each pixel is black or not. For example, the color determination unit 130 determines whether each pixel is black or not, by comparing the RGB value of each pixel with a predetermined threshold. The color determination unit 130 may determine whether each pixel is black or not, where “black” includes solid black (#000000) to gray with a concentration up to a predetermined threshold (for example, #0C0C0C). In the case where a pixel is determined not to be black, the color determination unit 130 identifies the color of the pixel. The color determination unit 130 determines whether the color of each pixel is one of red, blue, green, magenta, yellow, and cyan, by comparing the RGB value of each pixel with predetermined thresholds. In the same manner, the color determination unit 130 may determine whether a pixel is white or not. As in the case of black, the color determination unit 130 may determine whether each pixel is white or not, where “white” includes solid white (#ffffff) to gray with a concentration up to a predetermined threshold (for example, #e2e2e2). Additionally, any threshold may be used in determination of each color. The color determination unit 130 stores the determination result in the storage unit 180, in association with each pixel.

Additionally, in the following, a color that is neither white nor black may be described as “chromatic color”. A chromatic color is red, blue, green, magenta, yellow, or cyan, for example. Furthermore, a description may be given by referring to a pixel with a chromatic color as “chromatic pixel”. Furthermore, a description may be given by referring to a pixel that is white as “white pixel”, and a pixel that is black as “black pixel”.

The correction unit 140 corrects the depth information of each pixel based on the determination result from the color determination unit 130. The correction unit 140 performs a correction process for the depth value of each pixel, in an order from a top left pixel in the subject region 50a shown in FIG. 3. Specifically, the correction unit 140 performs the correction process in an order of d[0][0], d[0][1], d[0][2], . . . d[0][6], d[1][0], d[1][1], . . . . When the correction process is complete for d[14][6] at bottom right, the correction unit 140 performs the correction process for the subject regions 50b and 50c, in the same manner as for the subject region 50a.

The correction unit 140 performs a different correction process depending on a color of a correction target pixel that is to be corrected. Specifically, the correction unit 140 performs a different correction process depending on whether the correction target pixel is a white pixel, a black pixel, or a chromatic pixel. Specifically, the correction unit 140 does not correct the depth information in the case where the correction target pixel is a white pixel, and corrects the depth information by a method described below in the case of a black pixel or a chromatic pixel.

### <Correction Method for Chromatic Pixel>

First, a correction method for the chromatic pixel will be described.

In the case where the correction target pixel is a chromatic pixel, the correction unit 140 corrects the depth information of the correction target pixel based on correction information that is associated with the color of the correction target pixel. The correction information here includes information about correction of the depth information. In the present embodiment, a correction table 181 that is stored in the storage unit 180 in advance is used as the correction information, but the correction information may be provided in any form without being limited thereto.

For example, a color to be determined by the color determination unit 130 and a correction value for the depth information are associated with each other in the correction table 181. The correction table 181 may be provided for each color, or correction of a plurality of colors may be performed using one table. Furthermore, a plurality of correction tables 181 may be provided according to properties of the RGB sensor 200. Moreover, a different correction table 181 may be provided depending on whether a capturing environment is indoors or outdoors.

Furthermore, the correction unit 140 further corrects the depth information of the pixel according to whether the capturing environment of the captured image is indoors or outdoors. The correction unit 140 detects a color temperature and an amount of exposure of the capturing environment according to the AWB information and the AE information, and determines whether the capturing environment is indoors or outdoors based on the same. The correction unit 140 offsets an amount of correction according to the correction table 181, based on the capturing environment, and further corrects the depth value of the chromatic pixel.

### <Correction Method for Black Pixel>

Next, a correction method for the black pixel will be described.

In the case where the correction target pixel is a black pixel, the correction unit 140 corrects the depth information of the correction target pixel based on the depth information of a chromatic pixel that is in a neighborhood of the correction target pixel. Specifically, in the case where the correction target pixel is a black pixel, the correction unit 140 discards the depth information of the correction target pixel acquired by the acquisition unit 120. The correction unit 140 corrects the depth information of the correction target pixel by interpolating the discarded depth information of the correction target pixel based on the depth information of a chromatic pixel that is in the neighborhood. Additionally, “to discard” may mean not only a case of discarding an original value, but also aspect of using an interpolated value while storing the original value.

The correction method for a black pixel includes a plurality of patterns as described below, depending on an interpolation method of the discarded depth information. The correction unit 140 may select and perform one of the patterns, or may select and perform a plurality of the patterns.

Additionally, in the following description, a description may be given by expressing pixels corresponding to positions 1, 2, . . . , n as pixels 1, 2, . . . , n, and the depth values corresponding to each pixel as D1, D2, . . . , Dn.

### (First Correction Method)

First, a first correction method for the black pixel will be described.

In the first correction method, the correction unit 140 interpolates the depth value of the correction target pixel based on the depth values of chromatic pixels that are in the neighborhood of the black pixel in four directions of up, down, left, and right.

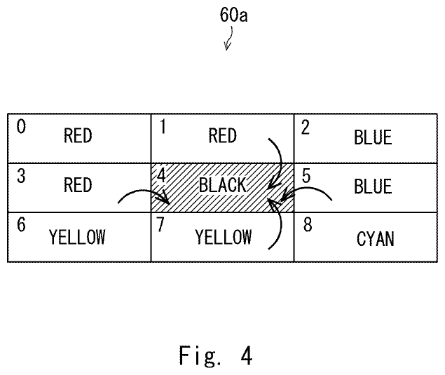

FIG. 4 is an explanatory diagram of the first correction method for the black pixel. An array 60a shown in FIG. 4 shows an example of a part of the subject region described above, and the same applies also to the following diagrams. The array 60a includes pixels 0, 1, 2, . . . , 8 in the subject region. In the array 60a, the pixel 4 is a black pixel. Furthermore, the pixels 0 to 3, 5 to 8 in the neighborhood of the pixel 4 are chromatic pixels. Additionally, colors red, blue, yellow and the like of the chromatic pixels are merely examples, and the same applies to the following diagrams.

The correction unit 140 identifies the chromatic pixels that are in a closest neighborhood of the pixel 4 in the four directions of up, down, left, and right. In the example in FIG. 4, the correction unit 140 identifies the pixels 1, 3, 5, 7 with chromatic colors that are adjacent to the pixel 4 in the directions of up, left, right, and down of the pixel 4. The correction unit 140 discards the depth value of the pixel 4 acquired by the acquisition unit 120, and interpolates the discarded depth value based on the depth values of the pixels 1, 3, 5, 7 with chromatic colors that are identified. Specifically, the correction unit 140 interpolates the depth value of the pixel 4 in such a way that an average value of depth values D1, D3, D5, D7 of the four pixels 1, 3, 5, 7 that are identified is made a depth value D4 of the pixel 4.

The D4 after interpolation is expressed by Equation (1) below.

D4=(D1+D3+D5+D7)/4 (1)

Additionally, the correction unit 140 desirably interpolates the depth value of the black pixel based on the depth values of the chromatic pixels that are adjacent to the black pixel in the manner described above, but this is not restrictive, and the depth value of the black pixel may also be interpolated based on the depth values of chromatic pixels in a range in the neighborhood.

### Modified Example of First Correction Method

In the first correction method described above, the correction unit 140 may perform interpolation expressed by Equation (1) by using the depth value of a chromatic pixel that is not adjacent to the black pixel.

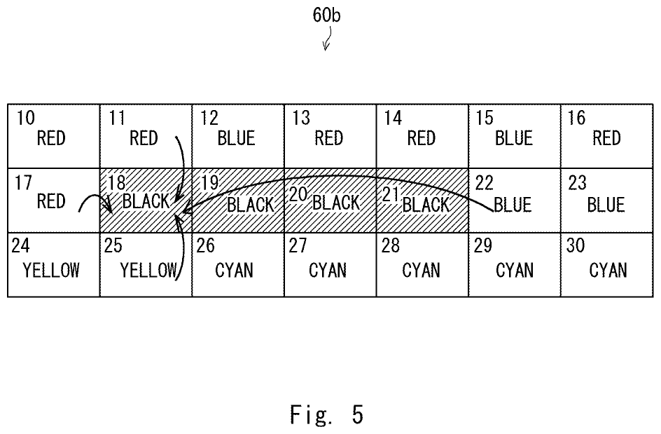

FIG. 5 is a diagram describing a modified example of the first correction method for the black pixel. An array 60b shown in FIG. 5 includes pixels 10, 11, 12, . . . , 30. In the array 60b, the pixels 18 to 21 are black pixels. Furthermore, pixels that are in the neighborhood of the black pixels and that are other than the black pixels are chromatic pixels.

For example, the correction unit 140 is to perform the correction process on the pixel 18.

The pixels 11, 17, 19, 25 are respectively adjacent to the pixel 18 in the directions of up, left, right, and down. It is assumed here that the pixels 11, 17, 19, 25 are identified in the same manner as by the first correction method described above, and the depth values thereof are used to interpolate the depth value of the pixel 18. Because the pixel 19 that is adjacent to the pixel 18 in the right direction is a black pixel, accuracy of the depth value after interpolation is possibly reduced due to use of the depth value of the pixel 19.

Accordingly, in the case where an adjacent pixel to be used for interpolation is a black pixel, the correction unit 140 identifies a chromatic pixel that is in the closest neighborhood in a direction where the adjacent pixel is positioned, and interpolates the depth value by using the depth value of the chromatic pixel that is identified. Accordingly, instead of the pixel 19, the correction unit 140 identifies the pixel 22 with a chromatic color that is in the closest neighborhood in the right direction of the pixel 18, and interpolates the depth value of the pixel 18 using the depth value of the pixel 22.

The correction unit 140 discards the depth value of the pixel 18 acquired by the acquisition unit 120, and interpolates the depth value of the pixel 18 using depth values D11, D17, D22, D25 of the pixels 11, 17, 22, 25 that are identified.

A depth value D18 of the pixel 18 after interpolation is expressed by Equation (2) below.

D18=(D11+D17+D22+D25)/4 (2)

Furthermore, the correction unit 140 also performs the correction process on the pixel 19. The pixel 19 is a black pixel, and the pixel 18 that is adjacent in the left direction is also a black pixel. The correction unit 140 performs the correction process in the order of array, and when the correction process is to be performed on the pixel 19, the depth value of the pixel 18 is the depth value D18 after interpolation expressed by Equation (2) mentioned above. Accordingly, at the time of performing correction on the pixel 19, the correction unit 140 may interpolate the depth value of the pixel 19 using the depth value D18 of the pixel 18 that is adjacent in the left direction.

Additionally, the pixel 20 that is adjacent to the pixel 19 in the right direction is a black pixel, and the depth value thereof is not yet corrected. Accordingly, as in the case of the pixel 18 described above, the correction unit 140 identifies the pixel 22 with a chromatic color that is in the closest neighborhood in the right direction, and performs interpolation using the depth value of the pixel 22 that is identified. Accordingly, the correction unit 140 identifies the pixels 12, 18, 22, 26. The correction unit 140 discards the depth value of the pixel 19 acquired by the acquisition unit 120, and interpolates the depth value of the pixel 19 using depth values D12, D18, D22, D26 of the pixels 12, 18, 22, 26 that are identified.

The depth value D19 of the pixel 19 after interpolation is expressed by Equation (3) below.

D19=(D12+D18+D22+D26)/4 (3)

(Second Correction Method)

Next, a second correction method for the black pixel will be described.

In the second correction method, the correction unit 140 interpolates the depth value of the correction target pixel based on the depth value of a pixel with lowest luminance among the chromatic pixels that are in the neighborhood of the black pixel.

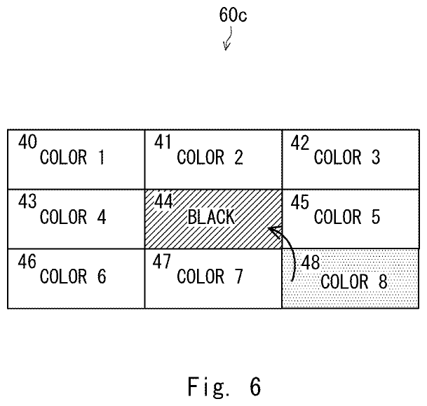

FIG. 6 is a diagram describing the second correction method for the black pixel. An array 60c shown in FIG. 6 includes pixels 40, 41, . . . , 48 in the subject region. In the array 60c, the pixel 44 is a black pixel. The pixels 40 to 43, 45 to 48 in the neighborhood of the pixel 44 are chromatic pixels with colors 1 to 4, 5 to 8, respectively. The pixels 40 to 43 may be black pixels after interpolation of the depth values.

In the following, the eight pixels 40 to 43, 45 to 48 around the pixel 44 will be collectively referred to as “eight pixels”.

First, the correction unit 140 calculates luminance values Y of the eight pixels based on the RGB values of the respective pixels. The luminance value Y may be calculated by Equation (4) below based on each component of RGB. Additionally, a factor used to multiply each component is not limited to the one below, and may be changed as appropriate.

Y=0.2126×R+0.7152×G+0.0722×B (4)

The correction unit 140 identifies a pixel whose luminance value Y is the smallest among the eight pixels based on calculation results of Equation (4), and interpolates the depth value of the correction target pixel using the depth value of the pixel that is identified. In the example in FIG. 6, the pixel 48 is assumed to have the smallest luminance value Y among the eight pixels. Accordingly, the pixel 48 is identified by the correction unit 140. The correction unit 140 discards the depth value of the pixel 44 acquired by the acquisition unit 120, and interpolates the depth value of the pixel 44 by taking a depth value D48 of the pixel 48 that is identified, as a depth value D44 of the pixel 44.

This enables interpolation of the depth value of the black pixel that is the correction target using the depth value of a pixel with the low luminance, or in other words, a pixel whose color is closest to black.

Additionally, a description is given here using the eight pixels in the neighborhood of the correction target pixel, but this is not restrictive. The correction unit 140 may perform interpolation of the depth value using the luminance values of more than eight or less than eight pixels. For example, in the case where the luminance values of eight pixels in the neighborhood cannot be acquired, such as in a case where the black pixel is positioned at an edge portion of the subject region, the correction unit 140 may perform interpolation using the number of luminance values that can be acquired.

### (Third Correction Method)

Next, a third correction method for the black pixel will be described.

In the third correction method, the correction unit 140 interpolates the depth values of a plurality of correction target pixels in a black pixel region where a plurality of black pixels is present continuously, based on the depth value of each of a plurality of chromatic pixels that is adjacent to the black pixel region.

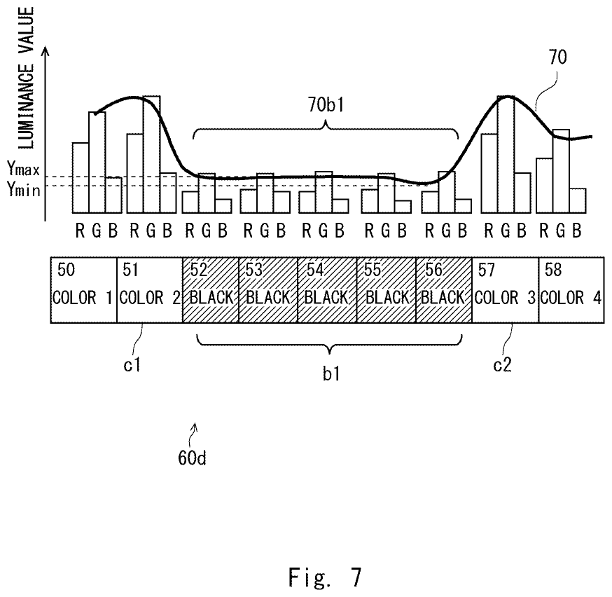

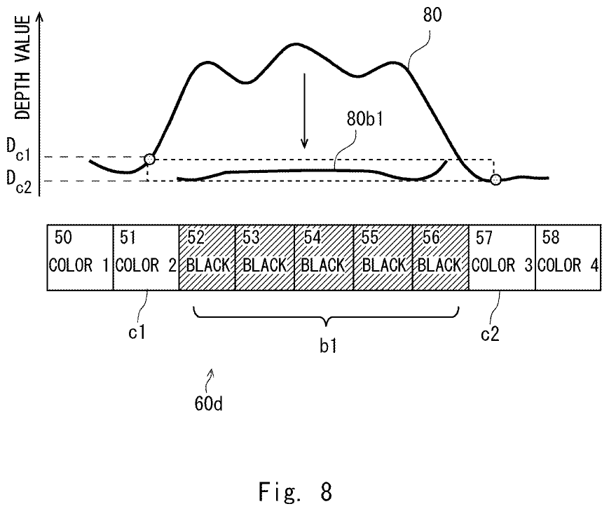

FIGS. 7 and 8 are explanatory diagrams of the third correction method for the black pixel. An array 60d shown in FIGS. 7 and 8 includes pixels 50, 51, . . . , 58 in the subject region. In the array 60d, the pixels 52 to 56 are black pixels forming a black pixel region b1. The pixels 50, 51 are present in the left direction of the black pixel region b1, and the pixels 57, 58 are present in the right direction. The pixels 50, 51, 57, 58 are chromatic pixels.

Furthermore, in the following, a pixel that is adjacent to the black pixel region b1 in the left direction will be referred to as an adjacent pixel c1, and a pixel that is adjacent in the right direction will be referred to as an adjacent pixel c2 for the sake of description. In the example in FIGS. 7 and 8, the adjacent pixel c1 is the pixel 51, and the adjacent pixel c2 is the pixel 57.

First, the correction unit 140 calculates a luminance level of each pixel in the array 60d. The luminance level indicates a degree of luminance of each pixel. Here, the luminance value Y of each pixel calculated by Equation (4) mentioned above is used as the luminance level; however, this is not restrictive, and the luminance level may also be calculated by other methods.

A luminance level curve 70 shown in FIG. 7 indicates an example of the luminance level of each pixel in the array 60d. The correction unit 140 generates the luminance level curve 70 of the array 60d from the luminance level of each pixel. Moreover, of the luminance level curve 70, a part corresponding to the black pixel region b1 is a luminance level curve 70b1.

Additionally, Yₘₐₓ and Yₘᵢₙ shown in FIG. 7 are each a maximum value and a minimum value of the luminance value Yin the black pixel region b1.

A depth value curve 80 shown in FIG. 8 indicates an example of the depth value of each pixel in the array 60d. The correction unit 140 generates the depth value curve 80 of the array 60d from the depth value of each pixel.

The correction unit 140 identifies the adjacent pixel c1, c2 that are adjacent to the black pixel region b1 in the left direction or the right direction. In the example in FIG. 8, the pixel 51 that is adjacent on the left of the pixel 52 at a left end of the black pixel region b1 is identified as the adjacent pixel c1, and the pixel 57 that is adjacent on the right of the black pixel 56 at a right end of the black pixel region b1 is identified as the adjacent pixel c2.

The correction unit 140 determines a difference range between the depth values of the adjacent pixels c1 and c2. When the depth values of the adjacent pixels c1 and c2 are given as D_{c1}, D_{c2} respectively, the difference range is expressed as (D_{c1}-D_{c2}). The correction unit 140 discards the depth value of each pixel in the black pixel region b1 acquired by the acquisition unit 120, and performs interpolation of the depth value of each pixel in the black pixel region b1 such that the depth value of each pixel falls within the difference range, by using the luminance level curve 70b1 shown in FIG. 7.

When a position of each pixel in the black pixel region b1 is given as n, the luminance value of the black pixel as the correction target, in the black pixel region b1, as Yn, the smallest luminance value in the black pixel region b1 as Yₘᵢₙ, a greatest luminance value in the black pixel region b1 as Yₘₐₓ, the depth value of the adjacent pixel c1 as D_{c1}, and the depth value of the adjacent pixel c2 as D_{c2}, a depth value Dn of the black pixel as the correction target, in the black pixel region b1, is expressed by Equation (5) below.

Dn=(Yn−Yₘᵢₙ)×{(D_{c1}−D_{c2})/(Yₘₐₓ−Yₘᵢₙ)}+D_{c2} (5)

The correction unit 140 interpolates the depth values of the black pixels 52 to 56 in the black pixel region b1 by using Equation (5) mentioned above. The correction unit 140 may thus interpolate the depth value of each pixel in the black pixel region b1 such that the depth value falls within a range between the depth values D_{c1}, D_{c2} of the adjacent pixels c1, c2 that are adjacent on both ends of the black pixel region b1. In FIG. 8, the depth value of each pixel in the black pixel region b1 after interpolation is indicated by a depth value curve 80b1.

Additionally, in FIGS. 7 and 8, an array of one row and nine columns is described as the array 60d, but this is not restrictive. The third correction method may also be applied to an array including a plurality of rows. Accordingly, the third correction method may be used also in a case where the black pixel region b1 is formed over a plurality of rows. In this case, the correction unit 140 identifies the chromatic pixel that is adjacent to the black pixel at a left end or a right end in the black pixel region b1 as the adjacent pixel c1, c2 respectively, for example.

Furthermore, in the case where the black pixel region b1 is formed over a plurality of rows, the correction unit 140 may identify the adjacent pixels c1, c2 from pixels in up/down directions of the black pixel region b1 instead of from pixels in the left/right directions. For example, the adjacent pixels c1, c2 that are adjacent in a manner of sandwiching the black pixel region b1 from the up or down directions may be identified. The correction unit 140 may also identify the adjacent pixels c1 and c2 by other methods.

### Modified Example of Third Correction Method

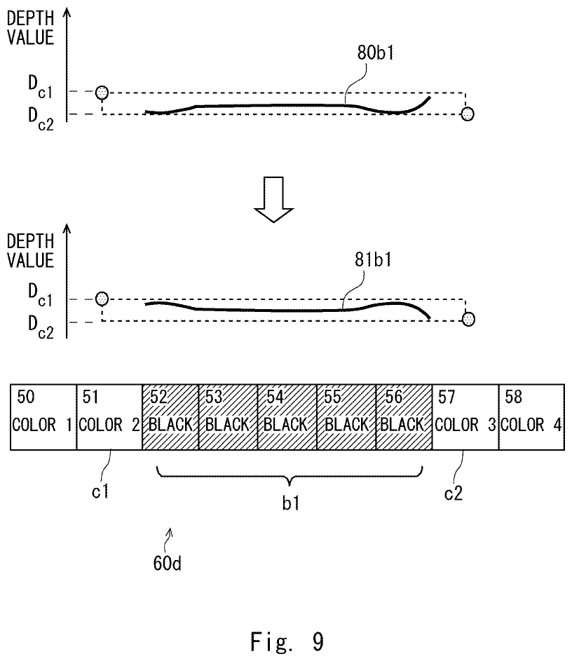

FIG. 9 is a diagram describing a modified example of the third correction method.

For example, it is assumed that a light is provided on the distance measurement sensor 300 side, and that the light is radiating illumination light on the subject. In this case, the smaller the distance between the distance measurement sensor 300 and the subject is, the stronger the illumination light hitting the subject, and the greater the distance is, the weaker the light hitting the subject.

A part of the subject that is strongly hit with the illumination light is positioned close to the distance measurement sensor 300. Accordingly, a pixel with a great luminance value has a smaller depth value than a pixel with a small luminance value. In contrast, a part of the subject that is weakly hit with the illumination light is positioned far from the distance measurement sensor 300. Accordingly, a pixel with a small luminance value has a greater depth value than a pixel with a great luminance value. By utilizing this, the correction unit 140 may further correct the depth value of the correction target pixel corrected by the third correction method, according to the luminance level of the correction target pixel.

For example, the correction unit 140 further corrects the depth value of each black pixel in the black pixel region b1 based on the luminance level curve 70b1 shown in FIG. 7 and the depth value curve 80b1 shown in FIG. 8. The correction unit 140 further corrects the depth value of each black pixel by converting the depth value of each pixel such that the depth value of each pixel is reduced as the luminance value of each pixel is increased. A depth value curve 81b1 shown in FIG. 9 is an example of a depth value curve after conversion. The depth value of the black pixel may thus be corrected based on a relationship of magnitude of the luminance levels of each pixel in the black pixel region b1.

### (Fourth Correction Method)

Next, a fourth correction method for the black pixel will be described.

In the fourth correction method, the correction unit 140 interpolates the depth value of the correction target pixel using spline interpolation for interpolating between pieces of data.

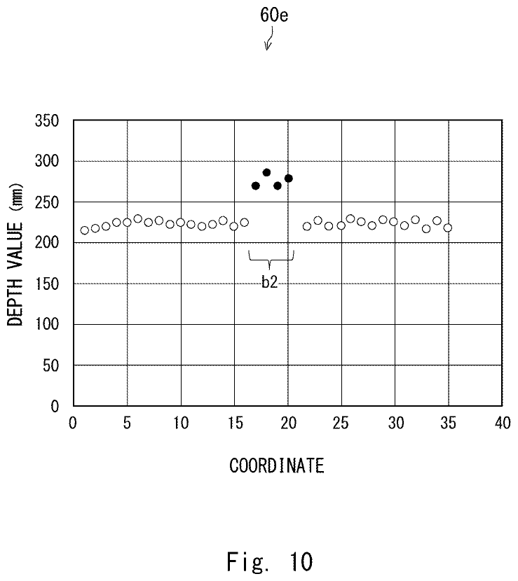

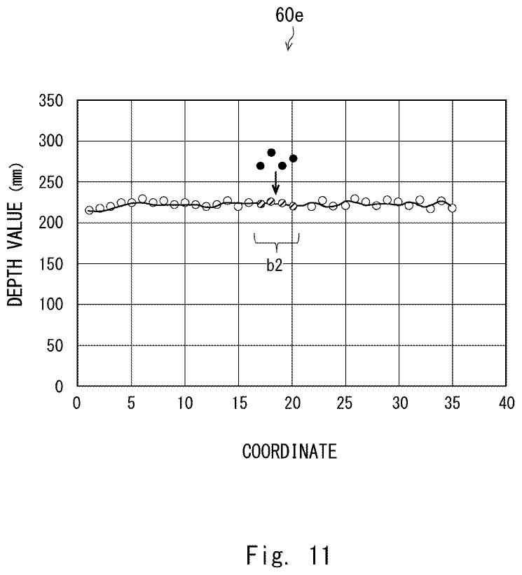

FIGS. 10 and 11 are explanatory diagrams of the fourth correction method for the black pixel.

FIG. 10 shows the depth values of an array 60e where a black pixel region b2 is included in the subject region, in the form of a graph. In FIG. 10, a horizontal axis shows coordinates corresponding to each pixel in the array 60e, and a vertical axis shows the depth values of each pixel. Furthermore, a white circle in the drawing indicates data of a chromatic pixel, and a black circle indicates data of a black pixel.

The correction unit 140 identifies the black pixel region b2, and discards the depth value of each pixel in the black pixel region b2 acquired by the acquisition unit 120. The correction unit 140 interpolates the discarded depth value using spline interpolation, based on the depth value of the chromatic pixel in the neighborhood. The correction unit 140 interpolates the depth value of each pixel in the black pixel region b2 in such a way that the depth value of each pixel becomes continuous to the chromatic pixel in the neighborhood.

FIG. 11 is a diagram showing data after spline interpolation is performed. Data of the black pixels after interpolation is indicated by hatching. The depth value of the black pixel may be interpolated in this manner by using the depth value of the chromatic pixel in the neighborhood. Additionally, the correction unit 140 may also interpolate the depth value of the black pixel by known interpolation methods such as linear interpolation and polynomial interpolation, for example.

The first to fourth correction methods for the black pixel are as described above.

The correction unit 140 may perform correction by selecting one of the correction methods, or may perform correction by combining some of the correction methods. For example, the correction unit 140 may perform correction of the correction target pixel by selecting one correction method from the first to fourth correction methods according to the number of black pixels included in the black pixel region, a shape of the black pixel region or the like. The correction unit 140 may also select a correction method according to any condition such as the number of chromatic pixels in the neighborhood of the black pixel, or a proportion of the black pixels or chromatic pixels in the entire subject region.

The correction unit 140 performs the correction on the chromatic pixel and the black pixel for all the arrays in the subject region 50a by using the correction methods as described above. When correction is complete for the subject region 50a, the correction unit 140 subsequently performs the correction process on the subject region 50b. The correction process is ended when the process is over for the subject regions 50a to 50c detected in the captured image P.

A description will be further given by referring back to FIG. 1.

The storage unit 180 is a storage apparatus for storing various pieces of information. The storage unit 180 stores in advance the correction table 181 described above. Furthermore, the storage unit 180 stores programs for implementing each function of the image processing apparatus 100.

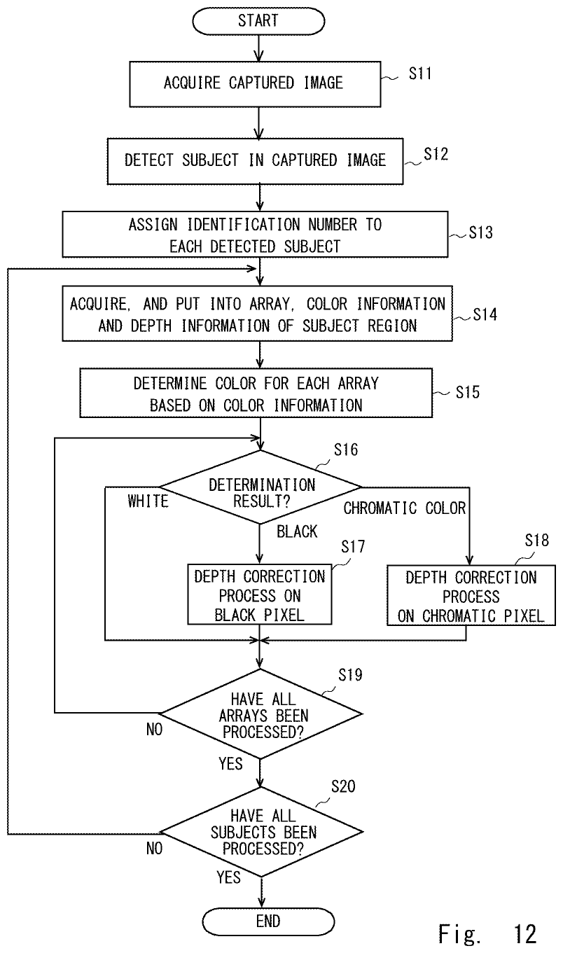

Next, a process that is performed by the image processing apparatus 100 will be described with reference to FIG. 12. FIG. 12 is a flowchart of a process that is performed by the image processing apparatus 100. Each functional unit used below corresponds to the one shown in FIG. 1. Furthermore, the description will be given while referring to FIGS. 2 to 11 as appropriate.

The detection unit 110 acquires a captured image from the RGB sensor 200 (S11). A description is given here assuming that the captured image P shown in FIG. 2 is acquired. Additionally, the AWB process and the AE process are performed on the captured image P by the RGB sensor 200.

The detection unit 110 detects a subject in the captured image P using a known object detection technique (S12). In the example shown in FIG. 2, the detection unit 110 detects the subject regions 50a to 50c corresponding, respectively, to the dog, the bicycle, and the truck that are the subjects. The subject regions 50a to 50c are regions within circumscribed rectangles of the respective subjects, for example.

Next, the detection unit 110 assigns the identification number to each subject that is detected (S13). The detection unit 110 assigns, as the identification numbers, “50a”, “50b”, and “50c” to the subject regions including the dog, the bicycle, and the truck, respectively.

The acquisition unit 120 acquires the color information and the depth information of the pixels included in the subject region 50a, and arranges the same in an array as shown in FIG. 3 (S14). The color information is the RGB value output from the RGB sensor 200, and the depth information is the depth value output from the distance measurement sensor 300. The image processing apparatus 100 performs the following processes on the correction target pixels in the subject region 50a, in the order of this array.

The color determination unit 130 determines the color of the pixel on a per-pixel basis, based on the color information that is acquired by the acquisition unit 120 (S15). For example, the color determination unit 130 determines whether the pixel is black or not, by comparing the RGB value of each pixel with a predetermined threshold. In the case where the pixel is not determined to be black, the color determination unit 130 identifies the color of the pixel. The color determination unit 130 determines the color of each pixel to be one of red, blue, green, magenta, yellow, and cyan, by comparing the RGB value of each pixel with predetermined thresholds. In the same manner, the color determination unit 130 may also determine whether the pixel is white or not. Additionally, any threshold may be used for determination of each color. The color determination unit 130 stores the determination result in the storage unit 180, in association with each pixel.

The correction unit 140 performs the correction process by taking each pixel as correction target pixels, successively from a top left pixel in the subject region 50a. The correction unit 140 acquires the determination result from the color determination unit 130, and performs a different correction process depending on the color of each pixel (S16). In the case where the correction target pixel is a white pixel (“white” in S16), the correction unit 140 proceeds to a process in step S19 without performing correction.

In the case where the correction target pixel is a black pixel (“black” in S16), the correction unit 140 performs a depth correction process on the black pixel by using any of the first to fourth correction methods for the black pixel described with reference to FIGS. 4 to 11 (S17). Specifically, the correction unit 140 discards the depth value of the black pixel acquired by the acquisition unit 120, and interpolates the discarded depth value based on the depth value of the chromatic pixel that is in the neighborhood of the black pixel, and thus corrects the depth value of the black pixel. Each of the correction methods are already described, and a detailed description here is omitted, and a simple description will be given as appropriate.

In the case where the first correction method is used, the correction unit 140 interpolates the depth value of the pixel based on the depth values of the chromatic pixels that are in the closest neighborhood of the black pixel in the four directions of up, down, left, and right. For example, as described with reference to FIG. 4, the correction unit 140 interpolates the depth value of the correction target pixel using the depth values of the chromatic pixels that are adjacent on the top, bottom, left, and right. Furthermore, as described with reference to FIG. 5, the correction unit 140 may also perform interpolation using the depth value of a chromatic pixel that is not adjacent to the black pixel

In the case where the second correction method is used, the correction unit 140 interpolates the depth value of the black pixel based on the depth value of a pixel with the lowest luminance among the chromatic pixels in the neighborhood of the pixel. As described with reference to FIG. 6, the correction unit 140 calculates the luminance value of each of eight pixels around the correction target pixel. The correction unit 140 performs interpolation in such a way that the depth value of the pixel with the lowest luminance is made the depth value of the correction target pixel.

In the case where the third correction method is used, the correction unit 140 interpolates the depth values of a plurality of pixels based on each depth value of a plurality of chromatic pixels that are adjacent to the black pixel region including the plurality of black pixels. As described with reference to FIG. 7, the correction unit 140 calculates the luminance value of each pixel included in the array, and generates the luminance level curve. The correction unit 140 identifies the chromatic pixels that are adjacent on both sides of the black pixel region, and determines a difference between the depth values of the chromatic pixels that are identified. As described with reference to FIG. 8, the correction unit 140 interpolates the depth value of each pixel in the black pixel region such that the depth value of the black pixel falls within the difference range. Moreover, as described with reference to FIG. 9, the correction unit 140 further corrects the depth value of the correction target pixel by converting the depth value such that the depth value is reduced, as the luminance value of the black pixel in the black pixel region is greater.

In the case where the fourth correction method is used, the correction unit 140 interpolates the depth value of the correction target pixel using spline interpolation for interpolating between pieces of data. As described with reference to FIGS. 10 and 11, the correction unit 140 discards the depth value before correction, in the black pixel region, and interpolates the depth value in the black pixel region such that the depth value of each pixel is made continuous to the chromatic pixel in the neighborhood.

A description will be given again by referring back to FIG. 12.

In the case where the correction target pixel is a chromatic pixel (“chromatic color” in S16), the correction unit 140 performs a depth correction process for the chromatic pixel (S18).

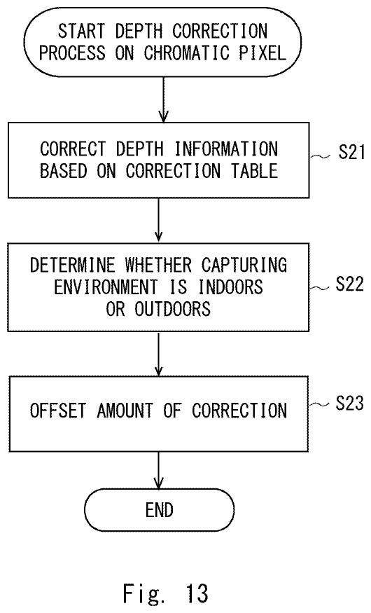

Here, the depth correction process for the chromatic pixel will be described with reference to FIG. 13. FIG. 13 is a flowchart showing the depth correction process for the chromatic pixel.

The correction unit 140 refers to the correction table 181 that is associated with the color of the correction target pixel, and corrects the depth value of the correction target pixel based on the correction table 181 (S21). Next, the correction unit 140 determines whether the capturing environment of the captured image P is indoors or outdoors (S22). For example, the correction unit 140 acquires information about AWB and AE performed by the RGB sensor 200, and performs the determination based on the color temperature and the amount of exposure of the captured image P.

The correction unit 140 offsets an amount of correction of the depth value based on the determination result above (S23). Accordingly, in addition to the correction using the correction table 181 provided in advance, the correction unit 140 may further correct the depth value based on whether the capturing environment of the captured image P is indoors or outdoors.

A description will be given again by referring back to FIG. 12.

The correction unit 140 determines whether the correction process is already performed or not on all the arrays in the subject region 50a (S19). In the case where there is an array that is not yet processed (NO in S19), the correction unit 140 returns to step S16 and repeats the following processes. In the case where the correction process is already performed on all the arrays in the subject region 50a (YES in S19), the next process is performed.

Next, the correction unit 140 determines whether image processing is already performed or not on all the subjects detected in the captured image P (S20). In the case where image processing is already performed on all the subjects (YES in S20), the process is ended. In the case where there is a subject that is not yet processed (NO in S20), the process returns to step S14 and subsequent processes are repeated.

As described above, with the image capturing system 1000 according to the present embodiment, the RGB sensor 200 and the distance measurement sensor 300 capture a subject, and output the color information and the depth information to the image processing apparatus 100. At the image processing apparatus 100, the detection unit 110 detects the subject region in the captured image, and the acquisition unit 120 acquires, and arranges, in an array, the color information and the depth information of the pixels included in the subject region.

The color determination unit 130 determines the color of each pixel based on the color information, and the correction unit 140 corrects the depth information of each pixel based on the determination result. The correction unit 140 can perform a different correction process depending on the color of the pixel. For example, in the case where the correction target pixel is a chromatic pixel, the correction unit 140 corrects the depth information of the correction target pixel based on the correction table 181 that is associated with the color of the pixel. Furthermore, the correction unit 140 determines whether the capturing environment of the captured image is indoors or outdoors, and further corrects the depth information of the correction target pixel according to the determination result.

Furthermore, in the case where the correction target pixel is a black pixel, the correction unit 140 may correct the depth information of the black pixel by selecting one or more from the plurality of correction methods.

For example, in the first correction method, the correction unit 140 corrects the depth information of the correction target pixel based on the depth information of a chromatic pixel that is in the neighborhood of the correction target pixel. The correction unit 140 identifies the chromatic pixels that are adjacent on the top, bottom, left, and right of the black pixel, and performs correction using the depth information thereof. Alternatively, in the case where the adjacent pixel is a black pixel, the correction unit 140 may identify a pixel that is a non-adjacent chromatic pixel that is in the closest neighborhood, and may use the depth information thereof.

Accordingly, the depth information of a black pixel may be corrected using the depth information of a chromatic pixel around the correction target pixel.

Furthermore, in the second correction method, the correction unit 140 identifies the pixel with the lowest luminance among the chromatic pixels in the neighborhood of the black pixel, and corrects the depth information of the correction target pixel based on the depth information thereof.

Accordingly, the depth information of the black pixel may be corrected using the depth information of a chromatic pixel that is close to black.

Furthermore, in the third correction method, the correction unit 140 may correct the depth information of a plurality of correction target pixels based on each depth information of a plurality of chromatic pixels that are adjacent to the black pixel region including a plurality of black pixels. For example, the correction unit 140 calculates the difference between the depth values of the chromatic pixels that are adjacent to pixels on both ends of the black pixel region, and corrects the depth value of the correction target pixel to fall within the difference range.

Accordingly, the depth information of the black pixel region may be made to be within the difference range of the depth information of the chromatic pixels that are adjacent on both ends. Furthermore, the correction unit 140 may further perform correction according to the luminance levels of the pixels in the black pixel region. The correction unit 140 may correct the depth value of each pixel by estimating whether the subject is close to or far from the luminance level of each pixel.

Moreover, in the fourth correction method, the correction unit 140 may correct the depth information of the correction target pixel using a known interpolation method such as spline interpolation. Accordingly, in the case where the depth values of the black pixel region and the depth values of the surrounding chromatic pixels are not continuous, the depth values of the black pixel region may be corrected to achieve continuous depth values.

In this manner, with the image capturing system 1000 according to the present embodiment, a different correction process may be performed depending on the color of the correction target pixel, and thus, the depth information may be appropriately corrected according to the color of the subject.

Additionally, the configuration of the image capturing system 1000 shown in FIG. 1 is merely an example. Each configuration of the image capturing system 1000 may be structured using an apparatus where a plurality of components is aggregated. For example, some or all of the functions of the image processing apparatus 100, the RGB sensor 200, and the distance measurement sensor 300 may be aggregated in one same apparatus. For example, one or both of the RGB sensor 200 and the distance measurement sensor 300 may be embedded in the image processing apparatus 100. Furthermore, each functional unit of the image processing apparatus 100 may be processed in a distributed manner using a plurality of apparatuses.

Additionally, the image processing apparatus 100 may also include an output unit (not shown) for outputting the captured image P before or after the correction process. The output unit is a display, for example. The output unit may also include an input function, such as a touch panel. Furthermore, the image processing apparatus 100 may be configured to be capable of outputting a 3D image based on the depth value.

### Example Configuration of Hardware

Each functional structural unit of the image processing apparatus 100, the RGB sensor 200, and the distance measurement sensor 300 may be implemented by hardware (such as a hard-wired electronic circuit) for implementing each functional structural unit, or by a combination of hardware and software (such as a combination of an electronic circuit and a program for controlling thereof). For example, in the present disclosure, any process may be implemented by execution of a computer program by a central processing unit (CPU).

The program includes a command group (or a software code) for causing a computer, when read by the computer, to perform one or more functions described in the embodiment. The program may be stored in a non-transitory computer-readable medium or a tangible storage medium. As an example, not a limitation, the non-transitory computer-readable medium or the tangible storage medium include a random-access memory (RAM), a read-only memory (ROM), a flash memory, a solid-state drive (SSD) or other memory technologies, a CD-ROM, a digital versatile disc (DVD), a Blu-ray (registered trademark) disc or other optical disc storages, a magnetic cassette, a magnetic tape, a magnetic disc storage or other magnetic storage devices. The program may be transmitted by a transitory computer-readable medium or a communication medium. As an example, not a limitation, the transitory computer-readable medium or the communication medium includes electrical, optical, acoustic, or other forms of propagation signals.

Additionally, the present disclosure is not limited to the embodiment described above, and may be changed as appropriate within the scope of the disclosure. For example, in the description above, the correction unit 140 is described as not performing a correction process on the depth value of a white pixel, but this is not restrictive. The correction unit 140 may also perform some kinds of correction on the depth value of a white pixel.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. An image processing apparatus comprising:
a detection unit configured to detect a subject region in a captured image;
an acquisition unit configured to acquire, on a per-pixel basis, color information and depth information of a pixel included in the subject region;
a color determination unit configured to determine a color of the pixel based on the color information; and
a correction unit configured to correct the depth information of the pixel based on a determination result from the color determination unit,
wherein, when the pixel is a chromatic pixel, the correction unit corrects the depth information of the pixel based on correction information that is associated with the color of the pixel.

2. The image processing apparatus according to claim 1, further comprising an image capturing unit configured to output the captured image to the detection unit after performing a process including at least one of an automatic white balance process and an automatic exposure process.

3. The image processing apparatus according to claim 1, wherein the correction unit further corrects the depth information of the pixel according to whether a capturing environment of the captured image is indoors or outdoors.

4. An image processing method comprising:
a detection step of detecting a subject region in a captured image;
an acquisition step of acquiring, on a per-pixel basis, color information and depth information of a pixel included in the subject region;
a color determination step of determining a color of the pixel based on the color information; and
a correction step of correcting the depth information of the pixel based on a determination result in the color determination step,
wherein, in the correction step, when the pixel is a chromatic pixel, the depth information of the pixel is corrected based on correction information that is associated with the color of the pixel.

5. An image processing apparatus comprising:
a detection unit configured to detect a subject region in a captured image;
an acquisition unit configured to acquire, on a per-pixel basis, color information and depth information of a pixel included in the subject region;
a color determination unit configured to determine a color of the pixel based on the color information; and
a correction unit configured to correct the depth information of the pixel based on a determination result from the color determination unit,
wherein, when the pixel is a black pixel, the correction unit corrects the depth information of the pixel based on the depth information of a chromatic pixel that is in a neighborhood of the pixel.

6. The image processing apparatus according to claim 5, wherein the correction unit corrects the depth information of the pixel based on the depth information of each chromatic pixel that is in the neighborhood of the black pixel in four directions of up, down, left, and right.

7. The image processing apparatus according to claim 5, wherein the correction unit corrects the depth information of the pixel based on the depth information of the pixel with lowest luminance among chromatic pixels that are in the neighborhood of the black pixel.

8. The image processing apparatus according to claim 5, wherein the correction unit corrects the depth information of the pixel in a black pixel region including a plurality of black pixels, based on the depth information of each of chromatic pixels that are adjacent to the black pixel region.
